(19) United States
(12) Patent Application Publication
(10) Pub. No.: US 2005/0185609 A1
(43) Pub. Date: Aug. 25, 2005

(54) Communication method, user terminal, network element and computer program

(76) Inventor: Esa Malkamaki, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/051,472

(22) Filed: Feb. 7, 2005

Related U.S. Application Data
(63) Continuation-in-part of application No. 10/827,525, filed on Apr. 20, 2004.

(30) Foreign Application Priority Data
Feb. 16, 2004 (FI) 20040243

(51) Int. Cl. H04Q 7/00

(52) U.S. Cl. 370/328

(57) ABSTRACT

In a radio system data units are associated with sequence numbers in a user terminal. The data units are arranged in order of the sequence numbers associated with the data units in the network element of the radio system.

This is a continuation-in-part application of U.S. patent application Ser. No. 10/827,525, filed Apr. 20, 2004, which claims priority to Finnish Patent Application Serial No. 20040243, filed Feb. 16, 2004. The disclosure of the prior United States patent application is hereby incorporated by reference herein in its entirety.

### FIELD

The invention relates to a communication method, a user terminal, a network element and a computer program in a radio system.

### BACKGROUND

In radio systems, such as the WCDMA (Wide band Code Division Multiple Access) or the UMTS (Universal Mobile Telecommunications System) utilizing packet-switched connection, the packets are usually protected against noise, fading and interference by channel coding, such as FEC (Forward Error correction Coding). In spite of protection, the reception of a packet may fail, which can be compensated for by retransmission. The retransmission takes place when the receiving transceiver of packets requests the faulty packet(s) to be repeated. This can be performed by an ARQ (Automatic Repeat Request) mechanism. In a receiver utilizing HARQ (Hybrid ARQ), the faulty packet and the retransmitted packet can be combined to increase the probability that the information of the packet is properly received. According to the OSI (Open Standards Interconnect) protocol model the HARQ function can be included in a physical layer or in a MAC (Medium Access Control) layer of the radio system, both layers residing below an RLC (Radio Link Control) layer. In this case, the communicated packets can be considered protocol data units (PDU) of the MAC layer.

In the WCDMA uplink the ARQ retransmission functionality is implemented in the RLC layer. The transmitter side RLC (in the UE) adds an RLC PDU number to each RLC PDU (both in acknowledged mode (AM) and unacknowledged mode (UM)). The receiver side RLC (in the RNC) then requests retransmissions (in AM) of missing PDUs and puts the PDUs in the original order based on these RLC PDU numbers. There is no other retransmission protocol specified below RLC, which implies that RLC PDUs are received in the same order as they were transmitted (there can be ‘holes’, i.e., some PDUs may be missing due to transmission errors, but no PDU can ‘pass’ another PDU below RLC). Retransmitted RLC PDUs are arranged in order on the basis of the RLC PDU numbers, i.e., put in the correct place. Since the corresponding RLC entities are in the UE and the RNC, the retransmissions cause significant delay.

Some enhancements have been proposed for the WCDMA uplink DCH. One of the enhancements is an introduction of a lower layer ARQ: new retransmission protocol is proposed between the user terminal and node B. This ARQ could be defined as a new physical layer function or as a new MAC layer function. In the latter case, a new MAC entity has to be added to Node B (where currently for uplink only physical layer functions are performed). We assume here that a new MAC entity called MAC-e is added to Node B to handle at least some of the ARQ related functions, such as generation of ACK/NACK. The ARQ has been proposed to be a so-called HARQ (Hybrid ARQ) where retransmitted blocks are (soft) combined with the earlier transmissions of the same block.

The enhanced uplink dedicated channel (E-DCH) of the WCDMA radio system is proposed to utilise the HARQ. Due to retransmission(s), however, the protocol data units of the RLC layer can be received in an order different from the order they were transmitted. Thus, for example, two successively transmitted data units may actually be received in opposite order and there may even be data units between them.

In the HSDPA (High Speed Downlink Packet Access) a reordering entity of the MAC-hs layer below the MAC-d layer reorders MAC-hs protocol data units. A MAC-hs protocol data unit waits in a queue before proceeding to MAC-d layer until all MAC-hs protocol data units having lower transmission sequence number have been received or a timer expires. In a similar manner, when enhanced uplink DCH (Dedicated CHannel) of the WCDMA system is used, reordering is proposed to be performed in the MAC-e layer below the MAC-d layer, either in the RNC (Radio Network Controller) or in node B.

There are, however, problems related to the reordering. If reordering is performed in node B, then the Iub traffic becomes more bursty when the reordering waits for some blocks and once they are received, sends many PDUs over the Iub. Furthermore, there are many problems related to the soft handover (SHO), i.e., the case where a user terminal is simultaneously connected to several node Bs. Here the SHO means that several node Bs receive the block from the user terminal and acknowledge it independently. Hence, the reordering is done independently. This has the problem that the first node B may be waiting for one block on order to be able to deliver the blocks to the RNC but some other node B may have received the same block already and therefore the user terminal will not retransmit it. On the other hand, the other node B may be waiting for another block, which the first node B has received correctly. Thus, some kind of alignment of the reordering queues in different node Bs is required. One way to avoid the problems is to perform the reordering in the RNC after the macro diversity combining.

The reordering could be done in the RNC in a recently proposed MAC-e entity below the MAC-d. Since MAC-d (in the transmitter side) can multiplex different logical channels into one transport channel and different logical channels can have different priorities, there can be transport blocks (MAC-d PDUs) with different priorities within one transport channel. The different priorities should be reordered separately, otherwise a higher priority PDU may have to wait for the reception of a missing lower priority PDU. Therefore, some priority information should be added to each MAC-e PDU (cf. QID of MAC-hs PDU) which increases the overhead.

The reordering of the blocks requires that each block has a unique sequence number which lengthens headers and increases signalling. In the HSDPA (High Speed Downlink Packet Access) communication, several MAC-d PDUs can be multiplexed into one MAC-hs PDU, and a transmission sequence number (TSN) is associated with each MAC-hs PDU. A MAC-hs PDU is then mapped to a transport block which is further transmitted over the air interface. Only one transport block is transmitted per one TTI (Transmission Time Interval) on an HS-DSCH (High Speed Downlink Shared Channel) and thus only one TSN is provided per one TTI. Due to MAC-hs multiplexing, a MAC-hs PDU may contain several MAC-d PDUs which can be of different size. The MAC-hs header therefore tells in addition to the TSN and the QID (queue id) also the size(s) of the MAC-d PDUs as well as the number of them. This leads to a rather complex MAC-hs header structure which causes extra overhead especially at low data rates.

### BRIEF DESCRIPTION OF THE INVENTION

An object of the invention is to provide an improved communication solution in a radio system.

According to an aspect of the invention, there is provided a communication method in a radio system comprising a network infrastructure, and at least one user terminal communicating with the network infrastructure over an air interface, the method comprising associating data units of each logical channel with sequence numbers in a transmitting user terminal.

According to another aspect of the invention, there is provided a communication method in a radio system comprising a network infrastructure, and at least one user terminal communicating with the network infrastructure over an air interface, the method comprising associating data units of each logical channel with sequence numbers in a medium access control-d entity, in a radio link control entity or in an entity between a radio link control entity and a medium access control-d entity of a user terminal.

According to another aspect of the invention, there is provided a communication method in a radio system comprising a network infrastructure, and at least one user terminal communicating with the network infrastructure over an air interface, the method comprising receiving, in the network infrastructure, data units of at least one logical channel associated with sequence numbers in the user terminal; and arranging the data units of each logical channel in a network element of the network infrastructure.

According to another aspect of the invention, there is provided a communication method in a radio system comprising a network infrastructure, and at least one user terminal communicating with the network infrastructure over an air interface, the method comprising associating each data unit of a logical channel in one transmission time interval with one sequence number and associating data units in successive transmission time intervals with successive sequence numbers in a transmitting user terminal.

According to another aspect of the invention, there is provided a computer program product of a radio system comprising a network infrastructure and at least one user terminal communicating with the network infrastructure over an air interface, the computer program product comprising data units of each logical channel that are associated with sequence numbers in a transmitting user terminal.

According to another aspect of the invention, there is provided a computer program product of a radio system comprising a network infrastructure, and at least one user terminal communicating with the network infrastructure over an air interface, the computer program product comprising data units of each logical channel that are associated with sequence numbers in a medium access control-d entity, in a radio link control entity or in an entity between the radio link control entity and the medium access control-d entity of a user terminal.

According to another aspect of the invention, there is provided a computer program product of a radio system comprising a network infrastructure and at least one user terminal communicating with the network infrastructure over an air interface, the computer program product comprising data units of a logical channel in one transmission time interval wherein each data unit is associated with one sequence number; and data units in successive transmission time intervals are associated with successive sequence numbers in a transmitting user terminal.

According to another aspect of the invention, there is provided a computer program product of a radio system comprising a network infrastructure and at least one user terminal communicating with the network infrastructure over an air interface, the computer program product comprising data units of each logical channel that are arranged, in a network element of the network infrastructure, in order of the sequence numbers associated with the data units in the user terminal.

According to another aspect of the invention, there is provided a network element of a radio system comprising a network infrastructure, and at least one user terminal is configured to communicate with the network infrastructure over an air interface, wherein the network element is a part of the network infrastructure; the network element is configured to receive data units of each logical channel from a user terminal, the data units being associated with sequence numbers in a user terminal; and the network element is configured to arrange the data units of each logical channel in order according to the sequence numbers associated with the data units.

According to another aspect of the invention, there is provided a radio network controller of a radio system comprising a network infrastructure, and at least one user terminal is configured to communicate with the network infrastructure over an air interface, wherein the radio network controller is configured to receive data units of each logical channel from a user terminal, the data units being associated with sequence numbers in a user terminal; and to arrange the data units of each logical channel in order according to the sequence numbers associated with the data units.

According to another aspect of the invention, there is provided a user terminal of a radio system comprising a network infrastructure, wherein the user terminal is configured to associate data units of each logical channel with sequence numbers.

According to another aspect of the invention, there is provided a radio system comprising a network infrastructure and at least one user terminal communicating with the network infrastructure over an air interface, wherein a user terminal is configured to associate data units of each logical channel with sequence numbers.

According to another aspect of the invention, there is provided a radio system comprising a network infrastructure and at least one user terminal communicating with the network infrastructure over an air interface, wherein a user terminal is configured to associate data units of each logical channel with sequence numbers in a medium access control-d entity, in a radio link control entity or in an entity between a radio link control entity and a medium access control-d entity.

According to another aspect of the invention, there is provided a radio system comprising a network infrastructure and at least one user terminal communicating with the network infrastructure over an air interface, wherein a user terminal is configured to associate data units of each logical channel with sequence numbers; the network infrastructure is configured to receive the data units of at least one logical channel associated with sequence numbers; and the network infrastructure is configured to arrange the data units of each logical channel in order of the sequence numbers.

According to another aspect of the invention, there is provided a radio system comprising a network infrastructure and at least one user terminal communicating with the network infrastructure over an air interface, wherein a user terminal is configured to associate each data unit of a logical channel in one transmission time interval with one sequence number and a user terminal is configured to associate data units in successive transmission time intervals with successive sequence numbers.

The communication method, the computer program, the user terminal, the element of the radio system, the radio network controller and radio system of the invention provide several advantages. Headers and signalling can be reduced since priority information is not needed and the PDUs in the same transmission time interval do not need unique sequence numbers.

### LIST OF DRAWINGS

In the following, the invention will be described in greater detail with reference to the preferred embodiments and the accompanying drawings, in which

FIG. 1 shows a radio system,

FIG. 2 illustrates an effect of HARQ process on the order of the PDUs,

FIG. 3 illustrates an OSI model of the radio system,

FIG. 4 illustrates a MAC-d entity in a user terminal,

FIG. 5 illustrates a MAC-d entity in a radio network controller,

FIG. 6 illustrates a block diagram of reordering in the radio network controller,

FIG. 7 illustrates data flow between different layers,

FIG. 8 illustrates data flow between different layers,

FIG. 9 shows two transmitted logical channels multiplexed into one transport channel,

FIG. 10A shows several PDUs of one transmission time interval associated with a common sequence number,

FIG. 10B shows several PDUs of one transmission time interval associated with one sequence number,

FIG. 11 shows PDUs in an E-DCH channel,

FIG. 12 shows PDUs in an E-DCH channel,

FIG. 13 illustrates a flow chart of the present solution,

FIG. 14 illustrates a flow chart of the present solution,

FIG. 15 illustrates a flow chart of the present solution, and

FIG. 16 illustrates a flow chart of the present solution.

### DESCRIPTION OF EMBODIMENTS

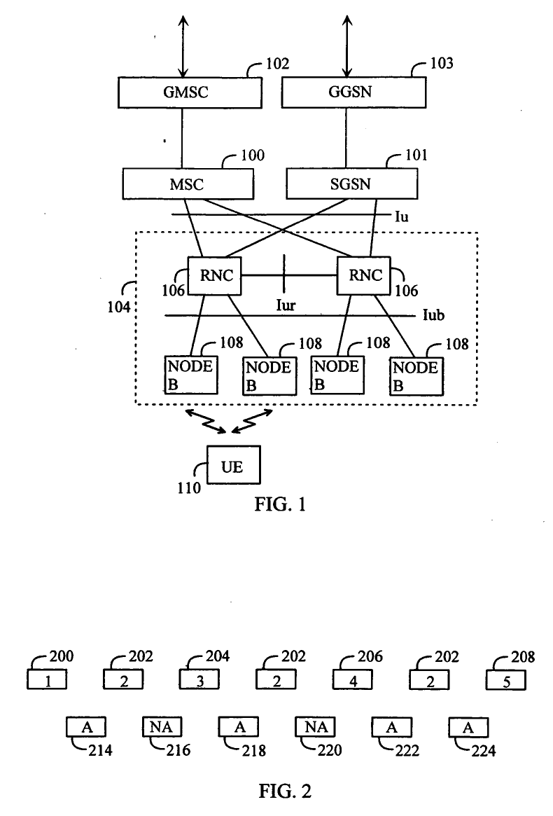

FIG. 1 illustrates the structure of a radio system. The radio system can be based on, for example, GSM (Global System for Mobile Communications) UMTS (Universal Mobile Telephone System) or WCDMA (Wide-band Code Division Multiple Access).

The core network may, for example, correspond to the combined structure of the GSM and GPRS (General Packet Radio System) systems. The GSM network elements are responsible for the implementation of circuit-switched connections, and the GPRS network elements for the implementation of packet-switched connections, some of the network elements being, however, shared by both systems.

A mobile services switching centre (MSC) 100 enables circuit-switched signalling in the radio system. A serving GPRS support node (SGSN) 101 in turn enables packet-switched signalling. All traffic in the radio system may be controlled by the MSC 100.

The core network may have a gateway unit 102, which represents a gateway mobile service switching centre (GMSC) for attending to the circuit-switched connections between the core network and external networks, such as a public land mobile network (PLMN) or a public switched telephone net-work (PSTN). A gateway GPRS support node (GGSN) 103 attends to the packet-switched connections between the core network and external net-works, such as the Internet.

The MSC 100 and the SGSN are connected to a radio access net-work (RAN) 104, which may comprise at least one radio network controller 106 controlling at least one node B 108. The radio network controller 106 can also be called a base station controller, and the node B can be called a base station. A user terminal 110 communicates with at least one node B 108 over an air interface.

The user terminal 110 can communicate with node Bs 108 using a GPRS method. Data in packets contain address and control data in addition to the actual traffic data. Several connections may employ the same transmission channel simultaneously. A packet-switching method is suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and use of the network. A network infrastructure of the radio system can be considered to include all other elements of the radio system except the user terminals 110 which are usually mobile.

When the user terminal 110 transmits a signal 200, such as a packet, to a node B 108, the node B 108 either receives it correctly or has a failure in reception. The node B 108 or the radio network controller 106 calculates a checksum (CRC=Cyclic Redundancy Check) and compares a checksum included in the packet with the calculated checksum of the packet. If the two checksums match, the packet is properly received. If, on the other hand, the checksums do not match, there is a failure in reception.

FIG. 2 represents retransmission and its effect on the order of the PDUs. In this example both the user terminal and the network infrastructure have buffer memories for storing PDUs. The first PDU 200 is successfully transmitted from the user terminal to the network infrastructure in the first TTI (Transmission Time Interval), which is acknowledged by an ACK (Acknowledgement) signal 214 from the network infrastructure. The second PDU 202 is transmitted, but as it fails, the network infrastructure transmits a NACK (Not acknowledgement) signal 216. The third PDU 204 is transmitted successfully and acknowledged with an ACK signal 218 from the network infrastructure. The second PDU 202 is retransmitted, but the retransmission fails again and the network infrastructure transmits a NACK signal 220. The fourth PDU 206 is successfully received and acknowledged by an ACK signal 222. The second PDU 202 is retransmitted for the second time and now the transmission is successful. The network infrastructure transmits an ACK signal 224. The transmission of PDUs continues similarly with the fifth PDU 208, etc. The retransmission causes the PDUs to be mixed and in this example the order becomes 1, 3, 4, 2, . . . which needs to be arranged in a proper order.

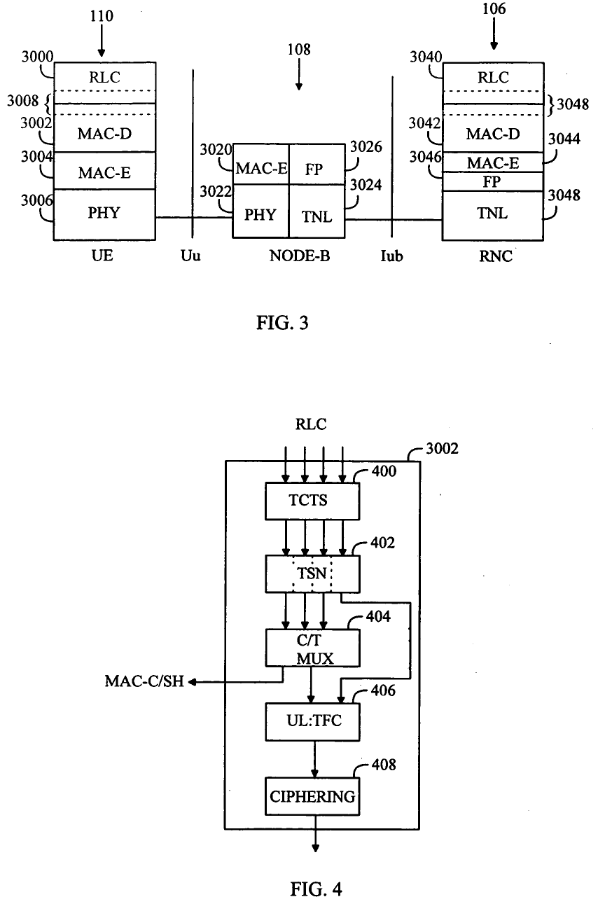

FIG. 3 shows the protocol architecture of the elements, for example, in the UMTS or WCDMA radio system. Using the OSI protocol model, the user terminal 110 may comprise a radio link control (RLC) entity 3000, a MAC-d entity 3002, a MAC-e entity 3004 and a physical entity 3006. The user terminal may also comprise an entity 3008 between the RLC entity 3000 and the MAC-d entity 3002.

The node B 108 may comprise a MAC-e entity 3020, a physical entity 3022, a transport network (TNL) entity 3024 and a framing protocol entity (FP) 3026.

The radio network controller 106 may comprise an RLC entity 3040, a MAC-d entity 3042, a MAC-e entity 3044, a framing protocol entity (FP) 3046 and a TNL entity 3048. The RNC may also comprise an entity 3048 between the RLC entity 3040 and the MAC-d entity 3042. The entities can be considered operational units accomplished by electronic circuits having processors and memories. The actual operations can be carried out using suitable computer programs.

The RLC entities 3000, 3040 in the RLC layer of the OSI model are the protocols that control the transmission over the air interface in the packet switched connection of the UMTS radio system. Hence, important features of the RLC layer are, for example, flow control and error recovery.

The MAC-d layer is not symmetric but the MAC-d entities 3002, 3042 differ to a certain extent in the user terminal 110 and in the RNC 106. The protocols of the MAC-d entities 3002, 3042, however, perform, for instance, multiplexing between logical channels and transport channels, since the air interface has logical channels, which can be mapped to transport channels, which, in turn, can be mapped to physical channels. The logical channels include, for example, a downlink (DL) broadcast control channel (BCCH), a (DL) paging control channel (PCCH), an uplink/downlink (UL/DL) dedicated control channel (DCCH), a (UL/DL) common control channel (CCCH), a (UL/DL) dedicated traffic channel (DTCH) and a unidirectional common traffic channel (CTCH).

The MAC-e layer can be used to handle, for example, enhanced uplink DCH specific functions. In the MAC-e entity of the user terminal the functions may include the following. One HARQ entity per one user terminal handles the hybrid ARQ protocol related functionality. One HARQ process per TTI is usually performed. A MAC-e header can be added to each MAC-e PDU (such as a E-DCH transport block). The header may include a sequence number for reordering.

In the MAC-e entity of the network infrastructure the functions may include the following. Fast scheduling of the E-DCH transmissions are performed between the user terminals. MAC-e generates one ACK/NACK signal of the HARQ operation with respect to one transmitted TTI. The received MAC-e PDUs can be reordered according to the received MAC-e sequence numbers. MAC-e header is removed, MAC-d PDUs extracted and delivered to the layer above (MAC-d).

The signalling between the user terminal and the node B takes place in the physical layer. The physical entities 3006, 3020 may also be in charge of the HARQ operation.

The TNL entities 3024, 3048 in the physical layer carry out the signalling between the node B 108 and the RNC 106. The framing protocol entities 3026, 3046 deal with headers of the physical channels, such as connection frame number (CFN), according to which, for instance, the macro diversity combining can be performed.

The node B 108 may comprise the MAC-d entity or a separate ordering entity if reordering of the data units is performed in the node B. In this case, the RNC may lack these entities.

The entities 3008, 3028, 3048 between the RLC layer and the MAC-d layer relate to the present solution where the user terminal 110 in the RCL entity 3000, the entity 3008, 3028, 3048 or in the MAC-d entity 3002 associates the PDUs with transmission sequence numbers and the node B 108 or the RNC 106 in the RCL entity 3040, the entity 3048 or in the MAC-d entity 3042 rearranges the PDUs in a proper order according to the transmission sequence number. The dashed line of the entities 3008, 3028, 3048 represents the possibility that the use of the transmission sequence number (TSN) and the reordering may be performed in RLC entities, MAC-d entities or in separate entities between the RLC and MAC-d layers.

FIG. 4 shows the MAC-d entity 3002 below the RLC entity 3000 in the user terminal. The transport channel type switching entity 400 can switch the mapping of one designated logical channel between common and dedicated transport channels. Since this is related to a change of radio resources, the channel switching is controlled by the radio resource control.

In the numbering entity 402 sequence numbers are associated with PDUs to be transmitted to the network infrastructure. This is performed by adding successive numbers in headers of successive PDUs in a predetermined window. The maximum value of the sequence number defines the length of the window. After all numbers reserved for sequence numbering have been used, the numbering starts from the beginning. The sequence numbers indicate the order in which the PDUs are transmitted. Instead of associating all PDUs with different sequence numbers, it is possible to associate each data unit of one transmission time interval with one sequence number, and associating data units in successive transmission time intervals with successive sequence numbers.

The C/T entity 404 can multiplex dedicated logical channels onto one transport channel. A C/T identification of each logical channel is added in the header of the PDUs of different logical channels, if several logical channels are multiplexed into one MAC-d flow or transport channel. The C/T identification is usually a 4-bit channel number in the header of a PDU. The TFC (Transfer Format Combination) entity 406 performs transport format and transport format combination selection under control of the radio resource control. In a ciphering entity 408 transparent mode data can be ciphered.

Instead of the place shown in FIG. 4, the numbering entity 402 may reside in the MAC-d entity 3002 above C/T entity 404 or in the RLC entity 3000 as the last operational entity according to an embodiment. The numbering entity 402 can be situated below C/T entity but also in that case each logical channel should have separate numbering. Hence, the numbering entity 402 may first detect the C/T field which is the same as the logical channel number and then associate the channel with a sequence number. The numbering entity 402 can number the PDUs in each logical channel separately, i.e. each channel has a distinct sequence of numbers.

According to another embodiment the numbering entity 402 may be a discrete entity of its own and the numbering entity 402 may reside between the RLC entity 3000 and the MAC-d entity 3002.

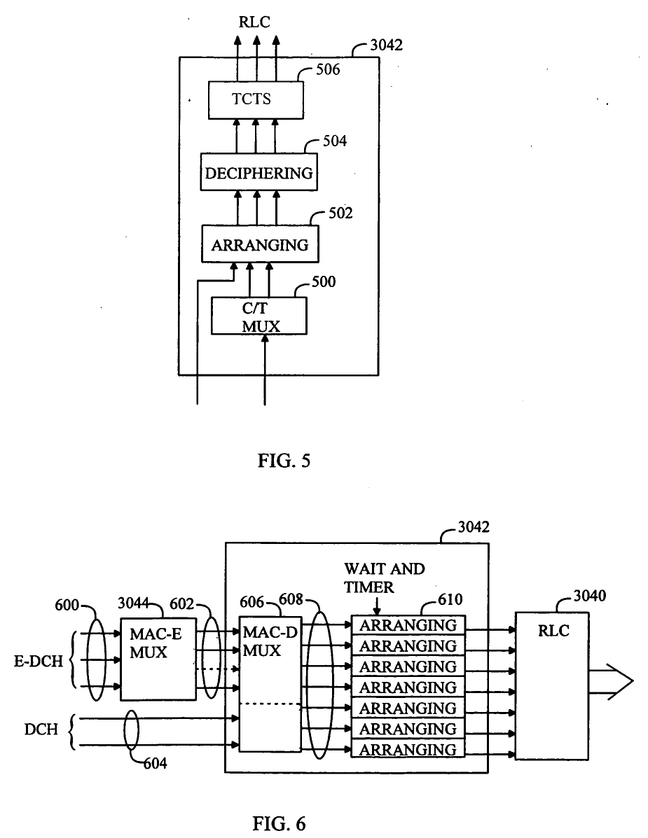

FIG. 5 shows the MAC-d entity 3042 below the RLC entity 3040 in the RNC. A C/T entity 500 demultiplexes a transport channel into several dedicated logical channels according to C/T field in the header of the PDUs if more than one dedicated channel is multiplexed onto a transport channel in the user terminal. The C/T header is removed in this entity.

The ordering entity 502 organizes the received PDUs in order according to the sequence number given by the numbering entity 402 of the user terminal as a discrete entity or as a part of the RLC entity 3000 or the MAC-d entity 3002. Since each logical channel can have only one priority, for instance, in the WCDMA and UMTS radio systems, the priority need not be signalled which saves space in the signaling overhead. A reordering queue can be used separately for each logical channel, which has the advantage that high priority PDUs need not wait for any lower priority PDUs delayed by failures in reception and retransmissions. The reordering queue can be accomplished by a memory. A window and at least one timer mechanism (similar to those of the HSDPA) can also be used to limit the waiting time of the PDUs and to deal with belated PDUs. The ordering entity 502 may remove the sequence number and forward the PDUs in a proper order to the RLC layer.

Ciphering can be removed in a deciphering entity 504. The transport channel type switching entity 506 performs a responsive operation to the transport channel type switching entity 400 in the user terminal.

If the reordering of the PDUs is performed in the RNC, a macro diversity combining (MDC) can be utilized. In the MDC, signals (PDUs) from different node Bs can be combined on the basis of the connection frame number in the RNC. The combining can be, for example, performed using a selection combining method. This gives some advantages, such as constant Iub traffic, MD combining without delay, no synchronization of several reordering queues etc.

FIG. 6 shows a block diagram of ordering in the MAC-d entity. In this case there are several E-DCH transport channels per one user terminal and per one TTI. Since the MAC-e entity 3044 maps each E-DCH transport channel 600 to one MAC-d flow 602, the MAC-e entity 3044 is not necessarily needed. The dashed arrow illustrates, however, the case when MAC-e multiplexing is used. Otherwise each transport channel is mapped into one MAC-d flow. The DCH channels 604 and MAC-e flows 602 are input to the MAC-d demultiplexer 606 (corresponds to C/T entity 500) which demultiplexes them into logical channels 608. The PDUs in each logical channel 608 can be arranged into a proper order in ordering units 610 (corresponding to ordering entity 502). The ordered PDUs are then input to the RLC entity 3040. This allows different error protection for different logical channels or transport channels within one TTI.

Instead of residing in the MAC-d entity 3042, the ordering entity 502 can also reside as a discrete entity separate from the MAC-d entity 3042 and the RLC entity 3040. Alternatively, the ordering entity 502 may reside in the RLC entity 3040.

Since reordering can be performed after logical channel demultiplexing in the RNC, i.e. as an operation before the RLC or as one of the first operations in the RLC, it could also be possible to reuse the RLC memory for reordering. It may be possible to perform the reordering in the same processor as the operation of the RLC entity.

The reordering can also be performed in the node B 108. Then the functions are the same as above, but the MAC-d 3020 entity can be substituted for the MAC-d entity 3042, the MAC-e entity 3020 is substituted for the MAC-e entity 3044 and the entity 3028 above MAC-d entity 3020 is substituted for the entity 3048. The entity 3028 may also be considered to be a part of the RLC entity in the node B.

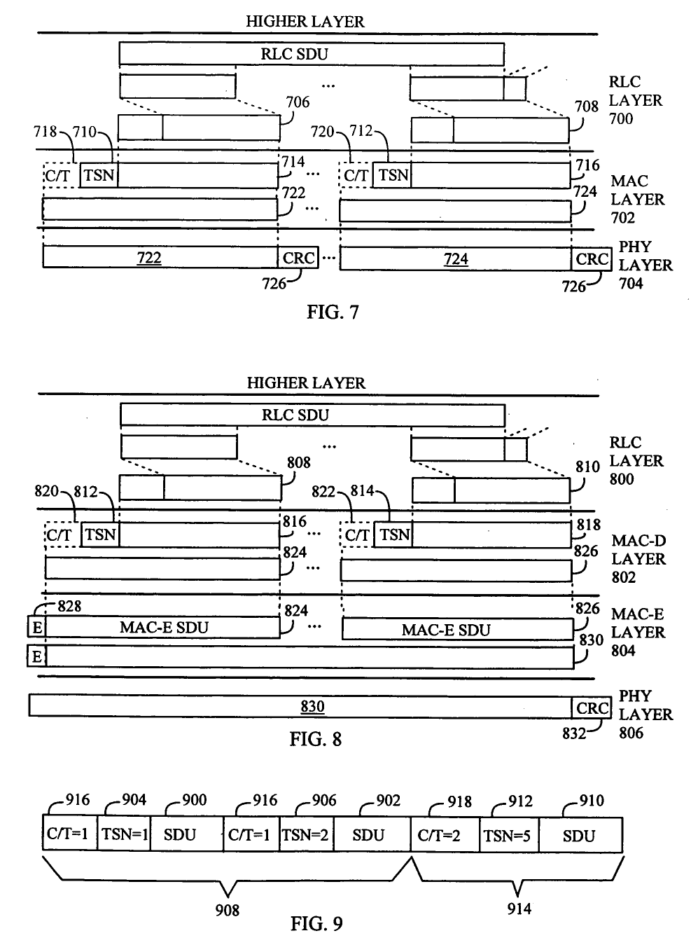

FIG. 7 shows non-transparent data flow between an RLC layer 700 and a physical layer 704. The RLC layer of the user terminal forms RLC data units 706 to 708 from the data units received from the higher layer. In the MAC-d layer 702 of the user terminal sequence numbers 710 to 712 are attached to MAC-d data units 714 to 716. Also C/T identification numbers 718 to 720 may be attached to the data units of different logical channels (if several logical channels are multiplexed into one transport channel) and data blocks 722 to 724 are formed. After that the data blocks proceed to the physical layer where CRC checksums 726 are associated to each data block 722 to 724.

After reception of the data blocks 722 to 724 in the physical layer 704 of the network infrastructure (usually node B) the associated CRC checksum 726 is compared with a calculated CRC checksum to check the quality of the reception. In the MAC-d layer 702 of the network infrastructure (usually RNC) the MAC-d data units 714 to 716 of each logical channel are arranged in a proper order according to the TSN numbers 710 to 712. The logical channels are demultiplexed according to the possible C/T identification number 718 to 720. After this the data units proceed forward to the RLC layer 700 and higher layers.

FIG. 8 shows non-transparent data flow between an RLC layer 800 and a physical layer 806 through a MAC-e layer 804. The RLC layer of the user terminal forms RLC data units 808 to 810 from the data units received from the higher layer. In the MAC-d layer 802 of the user terminal sequence numbers 812 to 814 are attached to MAC-d data units 816 to 818. Also C/T identification numbers 820 to 822 are attached to the data units of different logical channels, if several logical channels are multiplexed into one transport channel, and data blocks are formed. After that the data blocks 824 to 826 proceed to MAC-e layer 804 which may attach a MAC-e header 828 to data blocks 824 to 826 transmitted in one TTI and combines the data blocks 824 to 826 into a transport block 830. In this way, the overhead can be reduced. In the physical layer 806 CRC checksums 832 are associated to the transport block 830.

After reception of the transport block in the physical layer 806 of the network infrastructure (usually node B) the associated CRC checksum 832 is compared with a calculated CRC checksum to check the quality of the reception. In the MAC-e layer 804 the transport block 830 is split into data blocks 824 to 826 and possible MAC-e headers are removed in order to form data units 824 to 826 for the MAC-d layer 802. In the MAC-d layer 802 of the network infrastructure (usually RNC) the MAC-d data units 816 to 818 of each logical channel are arranged in a proper order according to the TSN numbers 812 to 814. The logical channels are demultiplexed according to the possible C/T identification number 820 to 822. Thereafter the data units proceed forward to RLC layer 800 and higher layers.

Each logical channel can be numbered separately. The logical channel number (the C/T field in the MAC-d header) is used to separate the logical channels if MAC-d multiplexing of several logical channels into one transport channel is used. Otherwise the logical channels can be separated on the basis of the transport channel used. The priorities in the WCDMA radio system are implemented such that each logical channel has a given priority. Now, if the sequence numbering for reordering purposes is done for each logical channel separately, there is no need to explicitly signal the priority thus saving on the inband signaling overhead.

If MAC-e multiplexing is not used, no MAC-e headers may need to be added to MAC-d PDUs (telling, e.g. the size and number of PDUs). The MAC-d PDUs with the (optional) C/T field and TSN number can then simply be passed to physical layer for channel coding and transmission.

FIG. 9 shows two transmitted logical channels multiplexed into one transport channel. As illustrated, MAC-d PDUs 900 to 902 can be numbered separately with sequence numbers 904 to 906 in the first logical channel 908. As an example, the first PDU 900 may have a sequence number TSN=1 and the second PDU may have a sequence number TSN=2. The same is also true for the second logical channel 914 where the PDUs 910 are associated with sequence numbers 912. The logical channels are separated from each other by C/T identification numbers 916 to 918. Transmission sequence numbers 800 to 802 may have, for example, 8 bits, since there can be several PDUs within one TTI. This is, however, less than required for MAC-e numbering, if each MAC-d PDU is given its own MAC-e header, since the priority identification number is not needed.

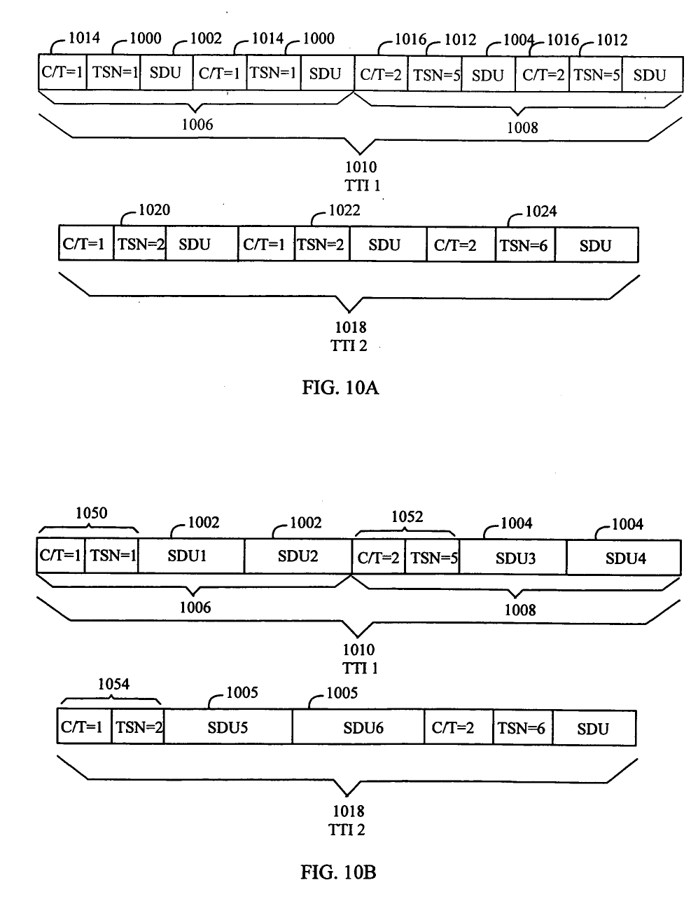

FIG. 10A shows a possibility to shorten the length of the MAC-d transmission sequence number. For example, the same transmission sequence number 1000 may be used for all MAC-d PDUs 1002 to 1004 of the logical channel 1006 transmitted within the first TTI 1010. In different logical channels 1006, 1008 different sequence numbers 1000, 1012 may be used and the logical channels are separated from each other by C/T identification numbers 1014 to 1016. In successive TTIs 1010, 1018 successive sequence numbers 1000 to 1012, 1020 to 1024 may be used.

FIG. 10B shows a possibility to compress a header in a case similar to that in FIG. 10A. MAC overheads can be reduced in a logical channel by combining the headers of MAC-d PDUs having the same transmission sequence number into a single MAC-e header or some other header of a MAC entity residing (directly) below MAC-d entity. In general, when it is a question of PDUs relating to one and the same logical channel and having one common transmission sequence number, the headers of PDUs of a first MAC entity may be combined into a single header of a second MAC entity residing below the first MAC entity. Hence, information on a transmission sequence of the PDUs of the first MAC entity can be attached to a header of the second MAC entity without attaching the information to a header of the first MAC entity. For example, the MAC-d PDUs 1002 (SDU1 and SDU2) may have a common header 1050 relating to one logical channel and transmission sequence. In a similar manner, the PDUs 1004 (SDU3 and SDU4) can have a common header 1052, and the PDUs 1005 (SDU5 and SDU6) can have a common header 1054.

Since the MAC-d entity makes the transport format combination selection, the MAC-d entity knows which MAC-d PDUs are transmitted within the same TTI. Only one transmission sequence number per one TTI is enough, because the MAC-d PDUs within one TTI cannot get into disorder and the reordering is only needed for PDUs in different TTIs. In this case, a 4 to 5 bit transmission sequence number may be enough (4 bits can be enough with 10 ms TTI, 5 bits may be needed with 2 ms TTI).

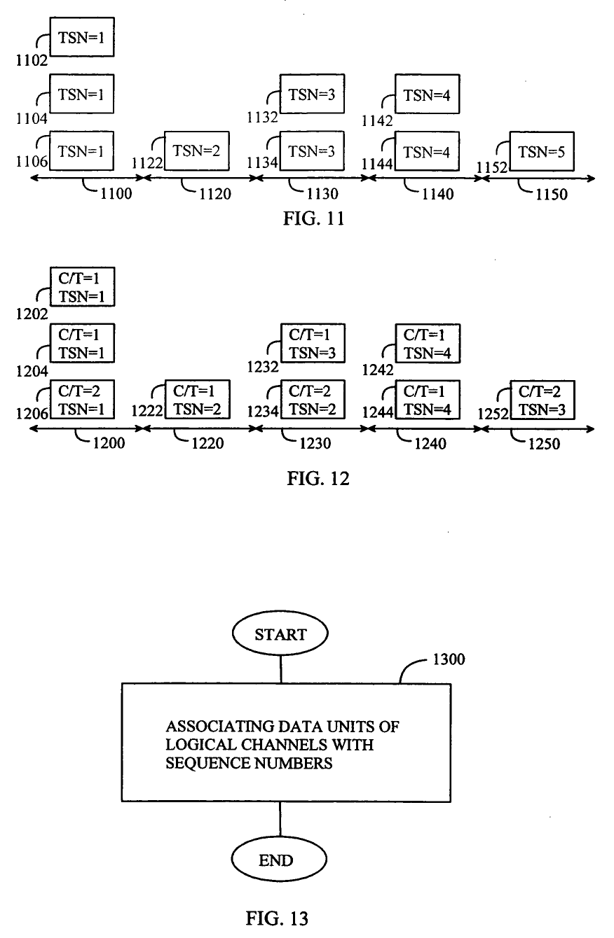

FIG. 11 illustrates transmission in an E-DCH channel in the case when no MAC-d layer multiplexing is used, i.e. the PDUS 1102, 1104 1106, 1122, 1132, 1134, 1142, 1144, 1152 do not include C/T field, since no separation in the logical channels is performed. In this example, the same sequence number is used for all MAC-d PDUs transmitted within one TTI, and successive sequence numbers are used in successive TTIs. Thus, in the first TTI 1100 the PDUs 1102 to 1106 are transmitted and all of them may have the sequence number TSN=1. In the second TTI 1120 the PDU 1122 is transmitted and it may have the sequence number TSN=2. In the third TTI 1130 the PDUs 1132, 1134 are transmitted and both of them may have the sequence number TSN=3. In the forth TTI 1140 the PDUs 1142, 1144 are transmitted and both of them may have the sequence number TSN=4. In the fifth TTI 1150 the PDU 1152 is transmitted and it may have the sequence number TSN=5, and so forth.

FIG. 12 illustrates transmission in an E-DCH channel in the case when MAC-d layer multiplexing is used, i.e. the PDUs 1202 to 1206, 1222, 1232, 1234, 1242, 1244, 1252 include C/T field, since separation in the logical channels is performed. Also in this example, the same sequence number is used for all MAC-d PDUs of the same logical channel transmitted within one TTI, and successive sequence numbers are used in successive TTIs. Thus, in the first TTI 1200 PDUs 1202 to 1206 are transmitted and the PDUs 1202, 1204 belong to the same logical channel (C/T=1) and their sequence number may be the same (TSN=1). A PDU 1106 belongs to a different logical channel with a C/T number C/T=2, but it may also have a sequence number TSN=1. In the second TTI 1220 a PDU 1202 is transmitted and it may have the sequence number TSN=2 and the logical channel number C/T=1. In the third TTI 1230 PDUs 1232, 1234 are transmitted. The PDU 1232 may have the logical channel number C/T=1 and the sequence number TSN=3, because it is transmitted in the third TTI. A PDU 1234 may have the logical channel number C/T=2 and the sequence number TSN=2, because it is transmitted in the second TTI according to the logical channel numbers (in the TTI 1220 there is no transmission of PDU(s) having the logical channel number C/T=2). In the forth TTI 1240 PDUs 1242, 1244 are transmitted and both of them may have the logical channel number C/T=1 and the sequence number TSN=4. In the fifth TTI 1250 a PDU 1252 is transmitted and it may have the logical channel number C/T=2 and the sequence number TSN=3 and so forth.

FIG. 13 illustrates a flow chart of an embodiment of the present method and the computer program. In step 1300, data units of each logical channel are associated with sequence numbers in a transmitting user terminal. The data units of each logical channel can be associated with sequence numbers in a medium access control-d entity, in a radio link control entity or in an entity between a radio link control entity and a medium access control-d entity.

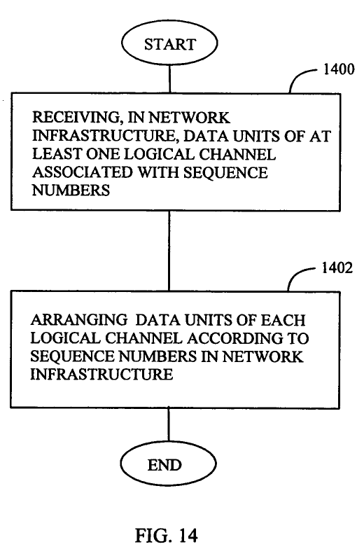

FIG. 14 illustrates a flow chart of an embodiment of the present method. In step 1400, data units of at least one logical channel associated with sequence numbers in the user terminal are received in the network infrastructure. In step 1402 the data units of each logical channel are arranged in a network element of the network infrastructure.

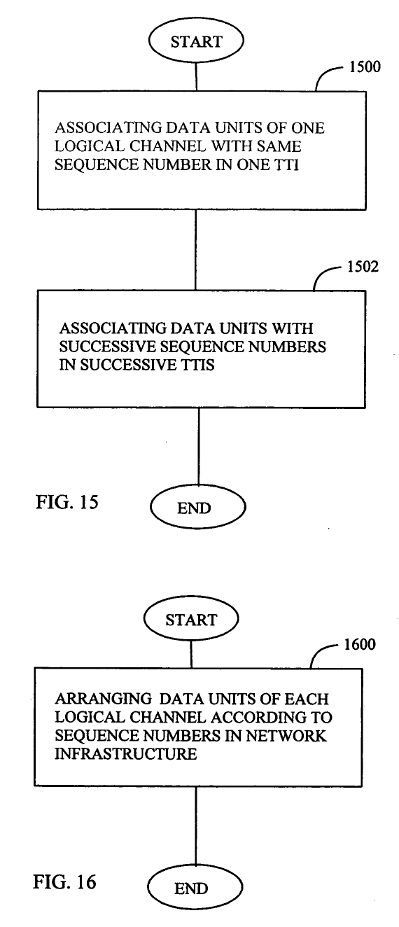

FIG. 15 illustrates a flow chart of an embodiment of the present method and the computer program. In step 1500 each data unit of a logical channel in one transmission time interval is associated with one sequence number. In step 1502 data units in successive transmission time intervals are associated with successive sequence numbers in a transmitting user terminal.

FIG. 16 illustrates a flow chart of an embodiment of the present computer program. In step 1600, the data units of each logical channel are arranged in order in a network element of the network infrastructure. The arranging is performed according to the sequence numbers associated with the data units in the user terminal.

Even though the invention is described above with reference to examples according to the accompanying drawings, it is clear that the invention is not restricted thereto but can be modified in several ways within the scope of the appended claims.

1. A communication method in a radio system comprising a network infrastructure, and at least one user terminal communicating with the network infrastructure over an air interface, the method comprising associating data units of each logical channel with sequence numbers in a transmitting user terminal.

2. The method of claim 1, further comprising:
receiving, in the network infrastructure, data units of at least one logical channel associated with sequence numbers in the user terminal; and
arranging, in a network element of the network infrastructure, the data units of each logical channel in order of the sequence numbers associated with the data units.

3. The method of claim 1, further comprising performing at least one retransmission including at least one data unit of a logical channel from the user terminal to the network infrastructure over the air interface.

4. The method of claim 1, further comprising:
associating each data unit of one transmission time interval with one sequence number; and
associating data units in successive transmission time intervals with successive sequence numbers.

5. The method of claim 1, further comprising:
associating data units of one transmission time interval with successive sequence numbers; and
associating data units in successive transmission time intervals with successive sequence numbers.

6. The method of claim 1, further comprising:
mapping medium access control-e flows from a medium access control-d entity to transport channels in a medium access control-e entity of the user terminal; and
associating data units with sequence numbers common to the medium access control-d entity and the medium access-e entity.

7. The method of claim 1, further comprising attaching, in a logical channel, information on a transmission sequence of protocol data units of a first medium access control entity having a common transmission sequence number to a header of a second medium access control_entity residing below the first medium access control entity.

8. The method of claim 1, further comprising transmitting the data units using enhanced uplink dedicated channel.

9. A communication method in a radio system comprising a network infrastructure, and at least one user terminal communicating with the network infrastructure over an air interface, the method comprising associating data units of each logical channel with sequence numbers in a medium access control-d entity, in a radio link control entity or in an entity between the radio link control entity and the medium access control-d entity of a user terminal.

10. The method of claim 9, further comprising arranging the data units of each logical channel in the radio link control entity, in the medium access control-d entity or in the entity between the radio link control entity and the medium access control-d entity of a network element of the network infrastructure.

11. The method of claim 9, further comprising arranging the data units in a radio network controller.

12. A communication method in a radio system comprising a network infrastructure, and at least one user terminal communicating with the network infrastructure over an air interface, the method comprising:
receiving, in the network infrastructure, data units of at least one logical channel associated with sequence numbers in the user terminal; and
arranging the data units of each logical channel in a network element of the network infrastructure according to the sequence numbers.

13. A communication method in a radio system comprising a network infrastructure, and at least one user terminal communicating with the network infrastructure over an air interface, the method comprising:
associating each data unit of a logical channel in one transmission time interval with one sequence number; and
associating data units in successive transmission time intervals with successive sequence numbers in a transmitting user terminal.

14. The method of claim 13, further comprising:
receiving, in the network infrastructure, data units of at least one logical channel associated with sequence numbers in the user terminal; and
arranging, in the network infrastructure, the data units in order of the sequence numbers associated with the data units in the network infrastructure.

15. The method of claim 13, further comprising performing at least one retransmission including at least one data unit of a logical channel from the user terminal to the network infrastructure over the air interface.

16. The method of claim 13, further comprising attaching, in a logical channel, information on a transmission sequence of protocol data units of a first medium access control entity having a common transmission sequence number to a header of a second medium access control_entity residing below the first medium access control entity.

17. The method of claim 13, further comprising:
associating data units with sequence numbers by giving a common medium access control-e header to medium access control-d data units having the same logical channel number and the same sequence number; and
arranging the data units in order of the sequence numbers associated with the data units in a medium access control-e entity in the network infrastructure.

18. A computer program product of a radio system comprising a network infrastructure and at least one user terminal communicating with the network infrastructure over an air interface, the computer program product comprising data units of each logical channel that are associated with sequence numbers in a transmitting user terminal.

19. The computer program product of claim 18, wherein information on a transmission sequence of protocol data units of a first medium access control entity having a common transmission sequence number is attached, in a logical channel, to a header of a second medium access control_entity residing below the first medium access control entity.

20. A computer program product of a radio system comprising a network infrastructure, and at least one user terminal communicating with the network infrastructure over an air interface, the computer program product comprising data units of each logical channel that are associated with sequence numbers in a medium access control-d entity, in a radio link control entity or in an entity between the radio link control entity and the medium access control-d entity of a user terminal.

21. The computer program product of claim 20, wherein the data units of each logical channel that are arranged in the radio link control entity, in the medium access control-d entity or in the entity between the radio link control entity and the medium access control-d entity of a network element of the network infrastructure.

22. The computer program product of claim 18, wherein in the network element of the network infrastructure, the data units of each logical channel transmitted from the user terminal are arranged in order of the sequence numbers associated with the data units.

23. The computer program product of claim 18, wherein data units of each logical channel are associated with sequence numbers in a medium access control-d entity, in a radio link control entity or at an entity between the radio link control entity and the medium access control-d entity of the user terminal.

24. The computer program product of claim 20, wherein the data units of each logical channel are arranged in order according to the sequence numbers in the medium access control-d entity, in the radio link control entity or in the entity between the radio link control entity and the medium access control-d entity of the network element of the network infrastructure.

25. The computer program product of claim 18, wherein at least one retransmission including at least one data unit of a logical channel from the user terminal to the network infrastructure over the air interface is performed.

26. A computer program product of a radio system comprising a network infrastructure and at least one user terminal communicating with the network infrastructure over an air interface, the computer program product comprising:
data units of a logical channel in one transmission time interval wherein each data unit is associated with one sequence number; and
data units in successive transmission time intervals are associated with successive sequence numbers in a transmitting user terminal.

27. The computer program product of claim 26, wherein the data units transmitted from the user terminal are arranged in order of the sequence numbers associated with the data units in the network infrastructure.

28. The computer program product of claim 26, wherein at least one retransmission including at least one data unit of a logical channel from the user terminal to the network infrastructure over the air interface is performed.

29. A computer program product of a radio system comprising a network infrastructure and at least one user terminal communicating with the network infrastructure over an air interface, the computer program product comprising data units of each logical channel that are arranged, in a network element of the network infrastructure, in order of the sequence numbers associated with the data units in the user terminal.

30. A network element of a radio system comprising a network infrastructure, and at least one user terminal is configured to communicate with the network infrastructure over an air interface, wherein
the network element is a part of the network infrastructure;
the network element is configured to receive data units of each logical channel from a user terminal, the data units being associated with sequence numbers in a user terminal; and
the network element is configured to arrange the data units of each logical channel in order according to the sequence numbers associated with the data units.

31. The network element of claim 30, wherein the radio network controller is configured to arrange the data units of each logical channel in order of the sequence numbers in a medium access control-d entity, in a radio link control entity or at an entity between a radio link control entity and a medium access control-d entity.

32. A radio network controller of a radio system comprising a network infrastructure, and at least one user terminal is configured to communicate with the network infrastructure over an air interface, wherein the radio network controller is configured
to receive data units of each logical channel from a user terminal, the data units being associated with sequence numbers in the user terminal; and
to arrange the data units of each logical channel in order according to the sequence numbers associated with the data units.

33. A user terminal of a radio system comprising a network infrastructure, wherein a user terminal is configured to associate data units of each logical channel with sequence numbers.

34. The user terminal of claim 33, wherein the user terminal is configured to attach, in a logical channel, information on a transmission sequence of protocol data units of a first medium access control entity having a common transmission sequence number to a header of a second medium access control entity residing below the first medium access control entity.

35. The user terminal of claim 33, wherein the user terminal is configured to associate data units of each logical channel with sequence numbers in a medium access control-d entity, in a radio link control entity or at an entity between a radio link control entity and a medium access control-d entity of a user terminal.

36. The user terminal of claim 33, wherein the user terminal is configured to transmit the data units to the network infrastructure and to perform at least one retransmission as a response to a request from the network infrastructure over an air interface, the retransmission including at least one data unit of a logical channel.

37. A radio system comprising a network infrastructure and at least one user terminal communicating with the network infrastructure over an air interface, wherein a user terminal is configured to associate data units of each logical channel with sequence numbers.

38. The radio system of claim 37, wherein the user terminal is configured to attach, in a logical channel, information on a transmission sequence of protocol data units of a first medium access control entity having a common transmission sequence number to a header of a second medium access controlentity residing below the first medium access control entity.

39. A radio system comprising a network infrastructure and at least one user terminal communicating with the network infrastructure over an air interface, wherein a user terminal is configured to associate data units of each logical channel with sequence numbers in a medium access control-d entity, in a radio link control entity or in an entity between a radio link control entity and a medium access control-d entity.

40. A radio system comprising a network infrastructure and at least one user terminal communicating with the network infrastructure over an air interface, wherein,
a user terminal is configured to associate data units of each logical channel with sequence numbers;
the network infrastructure is configured to receive the data units of at least one logical channel associated with sequence numbers; and
the network infrastructure is configured to arrange the data units of each logical channel in order of the sequence numbers.

41. A radio system comprising a network infrastructure and at least one user terminal communicating with the network infrastructure over an air interface, wherein a user terminal is configured to associate each data unit of a logical channel in one transmission time interval with one sequence number and the user terminal is configured to associate data units in successive transmission time intervals with successive sequence numbers.
